(19) United States
(12) Patent Application Publication
(10) Pub. No.: US 2007/0121835 A1
(43) Pub. Date: May 31, 2007

(54) Method for arbitrating audio signal output

(75) Inventor: John C. Wang, Taoyuan City (TW)

Correspondence Address: FISH & RICHARDSON PC, P.O. BOX 1022, MINNEAPOLIS, MN, 55440-1022, US

(73) Assignee: HIGH TECH COMPUTER CORP.

(21) Appl. No.: 11/522,089

(22) Filed: Sep. 15, 2006

(30) Foreign Application Priority Data
Sep. 19, 2005 (TW) 94132320

(51) Int. Cl. H04B 1/00

(52) U.S. Cl. 379/110.01

(57) ABSTRACT

A method for arbitrating audio signal output used in a portable electronic device, which comprises a speaker and two independent voice communication systems. When one voice communication system needs to send out a ringing signal, the voice communication system first detects the status of the other voice communication system. If the other voice communication system is idle, the ringing signal is sent out via the speaker; if the other voice communication system is in use, the ringing signal is not sent out, and an optional prompting signal is sent out via a receiver.

### RELATED APPLICATIONS

The present application is based on, and claims priority from, Taiwan Application Serial Number 94132320, filed Sep. 19, 2005, the disclosure of which is hereby incorporated by reference herein in its entirety.

### BACKGROUND OF THE INVENTION

1. Field of Invention

The invention relates to a method for arbitrating audio signal output and, in particular, a method for arbitrating audio signal output used in a portable electronic device with two or more voice communication systems.

2. Related Art

There are many changes in the types of electronic devices in recent years. Since the introduction of personal computer (PC) systems, different kinds of electronic products have been invented. PC systems have evolved into modem electronic products that are now able to perform many functions, including playing video and audio signals, processing images, and network communications. However, due to their large volumes and weights, many portable electronic devices with different functions have been introduced, such as MP3 music players, digital cameras, mobile phones, and personal digital assistants (PDA).

With various software and hardware designs and advances in manufacturing techniques, all sorts of small portable electronic devices are being integrated. For example, the so-called smart phones or smart PDA's not only have normal mobile phone functions of, but the smart phones or smart PDA's are also integrated with digital camera functions and PDA functions. Such portable electronic devices are just like portable PCs.

Not only can these electronic devices execute various application programs similar to a PC system, these electronic devices are capable of connecting and communicating with two major network systems, the usual computer network system (e.g., wireless area network) and the mobile phone network system (e.g., GSM or CDMA). In such multi-functional devices, there must be a mobile phone voice communication system for processing mobile phone signals and a digital data processing system for processing digital signals.

FIG. 1 is a schematic view of the internal structure of this type of electronic device. The internal processor 102 can execute many application programs and access digital data on usual computer networks 108. Therefore, if the processor 102 executes a real-time voice communication program and connects to a computer network 108, the electronic device can connect to a network phone system. On the other hand, the electronic device has a base-band controller 110 for processing mobile phone signals. Using the radio communication signals transmitted and received by a radio frequency (RF) module 112, the base-band controller 110 can connect to the usual mobile phone network, achieving functions of a mobile phone communication system.

The electronic device has two independent voice communication systems (i.e., the digital network phone system with the processor 102 and the mobile phone system with the base-band controller 110 and the RF module 112). The two voice communication systems can operate concurrently without interfering each other. However, simultaneous operation of two voice communication systems causes users lots of trouble. For example, such an apparatus usually has a speaker 104 and a receiver 106. The speaker 104 is used to play a ringing signal for the voice communication system. The receiver is used for the user to receive audio content. Thus, the sound played by the speaker 104 is clear and loud, whereas the sound played by the receiver is small and delicate. Suppose the user uses one of the voice communication systems and communicates by the receiver 106. If the other phone system has a conversation call at this moment and sends out a ring signal via the speaker 104, the user is suddenly interrupted.

Therefore, it is imperative to provide an arbitrating method to coordinate the voice signal conflict between the two phone systems when they are in use at the same time.

### SUMMARY OF THE INVENTION

An objective of the invention is to provide a method for arbitrating audio signal output used in a portable electronic device.

Another objective of the invention is to provide a method for arbitrating audio signal output among multiple voice communication systems.

A further objective of the invention is to provide a method for arbitrating audio signal output that is consistent with the user's habit.

To achieve the above objectives, one embodiment of the invention is implemented in the processor of an electronic device. The processor controls a speaker and connects to several voice communication systems. In this structure, each voice communication system can be considered as an audio signal source and can be either a mobile phone communication system or a network phone communication system. In one embodiment of the invention, once the processor receives a ringing signal, it determines which communication system the ringing signal comes from and determines the operating status of other voice communication systems. If the other voice communication systems are all idle, it directly uses the speaker to play the ring signal. If any of the other voice communication systems are in use, the ringing signal is not played. A receiver plays a prompting audio signal to notify the user.

Another embodiment of the invention takes into account the situation when the user uses the speaker to play audio signals during the conversation. That is, if other voice communication systems are detected to be in use and the user uses the speaker to play voices during the conversation in the above embodiment, the speaker is used to send out the ringing signal. Otherwise, the ringing signal is temporarily not played.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 shows the structure of an electronic device with multiple voice communication systems;

FIG. 2A is the flowchart of an embodiment method of the invention; and

FIG. 2B is the flowchart of another embodiment method of the invention.

### DETAILED DESCRIPTION OF THE INVENTION

The present invention will be apparent from the following detailed description, which proceeds with reference to the accompanying drawings, wherein the same references relate to the same elements.

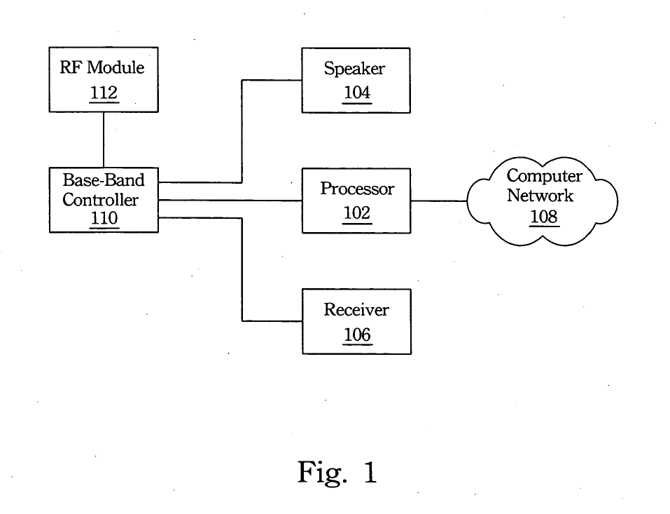

From the above discussion, it is clear that integrated portable electronic products will be the trend in the future. This type of electronic product is not only able to execute various kinds of application programs and communicate with computer networks in the same way as normal PC systems, but also has mobile phone functionality. To fulfill all these functions, an electronic device is usually equipped with at least a processor that is capable of processing digital data and computer network connections (the processor 102 in FIG. 1) and a mobile phone communication system (the base-band controller 110 and RF module 112 in FIG. 1). That is, the electronic device can be viewed as having two sets of voice communication systems. One of them is the mobile phone communication system (which may be compliant with any standard mobile phone system, such as GSM and CDMA). The other is a network phone system implemented with a real-time voice communication program executable in the processor (e.g., the currently commonly used MSN Messenger and Skype) along with a computer network (such as the computer network 108 in FIG. 1).

The processor also controls a speaker and a receiver. Generally speaking, the voice communication system can output two kinds of voice signals. One is the ringing signal that notifies the user to receive a call. The other is the voice signal in the conversation. In usual cases, the speaker outputs the ringing signal and the receiver outputs the voice signal. In the above-mentioned electronic device, there are two sets of independent voice communication systems. Therefore, we provide a method to coordinate the audio signal output between the two voice communication systems.

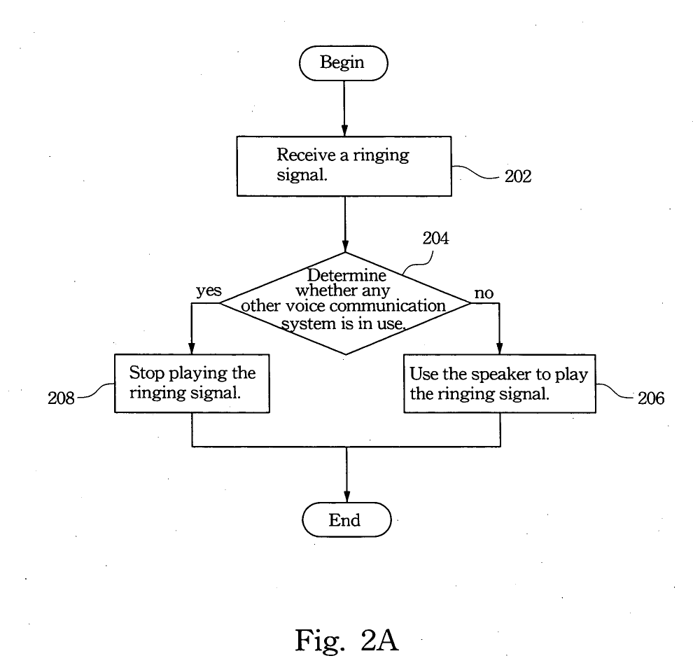

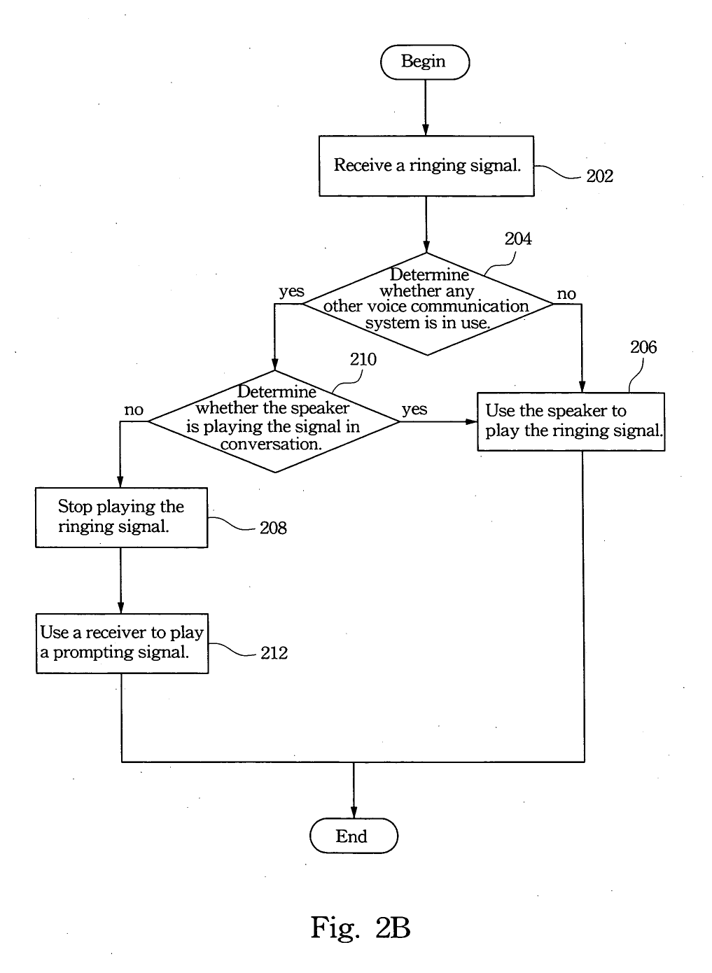

FIG. 2A shows a flowchart of an embodiment method in accord with the invention. First, the disclosed method is used in the processor of an electronic device with two or more voice communication systems, such as a mobile phone communication system and a network phone communication system. The electronic device further has a speaker and a receiver controlled by the microprocessor to play audio signals outputted by the voice communication system.

In step 202, the processor receives a ringing signal outputted by the application program and determines which voice communication system outputs that signal. Afterwards, in step 204, it determines whether any voice communication system other than the one that is sending out the ringing signal is in use. If the answer is no in step 204, it means that the user is not using the receiver. Step 206 follows, and the processor controls the speaker to play the ringing signal. If the answer is yes in step 204, it means that the user may be using the receiver for communications. If the speaker is used to play the ringing signal at this moment, the user may be shocked and confused. Therefore, step 208 follows, and the processor delays playing the ringing signal.

FIG. 2B shows the flowchart of another embodiment method of the invention. The procedure in FIG. 2A outlines the basic steps in the disclosed method. Therefore, other steps for the convenience of the user are added in FIG. 2B. Steps 202 and 204 are the same as in the previous embodiment. In step 204, if the determination result is no, the procedure also enters step 206 for the speaker to play the ringing signal, controlled by the processor. However, if the determination result is yes in step 204, the procedure enters step 210.

Since the processor determines that some other voice communication system is in use, it further determines in which way the user is communicating in step 210. This is because during the conversation, it may be a single user who uses the receiver to play the audio signal or multiple users who use the speaker to play the audio signal. In the case of using the speaker to play sounds, the disclosed procedure enters step 206 to directly play the ringing signal with the speaker. In the case of using the receiver to play sounds, the disclosed procedure enters step 208 to temporarily stop playing the audio signal. After step 208, although the ringing signal is stopped from being sent out, a soft prompting signal is sent via the receiver in step 212 to notify the user of the existence of this call.

The basic idea of the invention is to determine whether to play a ringing signal according to the usage of the voice communication systems in an electronic device. The commonly seen voice communication systems include the mobile phone communication system and the network phone communication systems. In practice, the disclosed embodiments do not impose any limitation on the type and number of voice communication systems. They can be adjusted according to needs.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An arbitrating method used in a processor that controls at least one audio signal output device and connects to multiple voice communication systems, the method comprising the steps of:
receiving an audio signal output from one of the voice communication systems;
determining the status of each of the voice communication systems; and
determining whether to use the audio signal output device to play the audio signal from the status of each of the voice communication systems.

2. The method of claim 1, wherein the voice communication systems include a mobile phone communication system and a network phone communication system.

3. The method of claim 2, wherein the mobile phone communication system includes a base-band controller and a radio frequency (RF) module.

4. The method of claim 2, wherein the network phone communication system includes a real-time voice communication program executed by the processor.

5. The method of claim 1, wherein the audio output device is a speaker.

6. The method of claim 1, wherein the audio signal is played by the audio signal output device when the voice communication systems are all idle and not played when any of the voice communication systems are in use.

7. An arbitrating method used in a processor that controls a speaker and connects to multiple voice communication systems, the method comprising the steps of:
(a) receiving an audio signal output from one of the voice communication systems;
(b) determining whether any of the voice communication systems is in use and executing step (c) if there is any or executing step (d) if there is none;
(c) stop playing the audio signal; and
(d) playing the audio signal using the speaker.

8. The method of claim 7, wherein the voice communication systems include mobile phone communication system and a network phone communication system.

9. The method of claim 8, wherein the mobile phone communication system includes a base-band controller and an RF module.

10. The method of claim 8, wherein the network phone communication system includes a real-time voice communication program executed by the processor.

11. The method of claim 7, wherein the controller further controls a receiver and the receiver plays a prompting audio signal after step (c).

12. An arbitrating method used in a processor that controls a speaker and connects to multiple voice communication systems, the method comprising the steps of:
(a) receiving an audio signal output from one of the voice communication systems;
(b) determining whether any of the voice communication systems is in use and executing step (c) if there is any or executing step (e) if there is none;
(c) determining whether the voice communication system in use is using the speaker and executing step (e) if yes or executing step (d) if no;
(d) stop playing the audio signal; and
(e) playing the audio signal using the speaker.

13. The method of claim 12, wherein the voice communication systems include a mobile phone communication system and a network phone communication system.

14. The method of claim 13, wherein the mobile phone communication system includes a base-band controller and an RF module.

15. The method of claim 13, wherein the network phone communication system includes a real-time voice communication program executed by the processor.

16. The method of claim 12, wherein the controller further controls a receiver and the receiver plays a prompting audio signal after step (c).

17. An electronic device, comprising:
multiple voice communication systems;
at least one audio signal output device; and
a processor used to control the audio signal output device and to receive an audio signal;
wherein the audio signal is outputted from one of the voice communication systems, and the processor determines whether to use the audio signal output device to play the audio signal from the status of each of the voice communication systems.

18. The electronic device of claim 17, wherein the voice communication systems include a mobile phone communication system and a network phone communication system.

19. The electronic device of claim 18, wherein the mobile phone communication system includes a base-band controller and an RF module.

20. The electronic device of claim 18, wherein the network phone communication system includes a real-time voice communication program executed by the processor.

21. The electronic device of claim 17, wherein the audio signal output device is a speaker.

22. The electronic device of claim 17, wherein the audio signal is played by the audio signal output device when the voice communication systems are all idle and not played when any of the voice communication systems is in use.
